(19) United States
(12) Patent Application Publication
(10) Pub. No.: US 2005/0275240 A1
(43) Pub. Date: Dec. 15, 2005

(54) Sun visor protector

(76) Inventor: Christopher Rogers, Long Beach, CA (US)

Correspondence Address: MICHAEL A. SHIPPEY, PH. D., 4848 LAKEVIEW AVENUE, SUITE B, YORBA LINDA, CA, 92886, US

(21) Appl. No.: 10/869,737

(22) Filed: Jun. 15, 2004

(51) Int. Cl. B60J 3/00

(52) U.S. Cl. 296/97.6

(57) ABSTRACT

The present invention is drawn to a cover for an automobile visor. The thin design of the present invention does not add significant bulk to the visor. This feature is welcome, as too much weight or bulk usually will cause the sun visor to sag and eventually work itself loose. The simplicity of the present embodiment is also its greatest feature. It is a low cost yet effective visor cover and protector. The cost and labor to produce such an invention would be very inexpensive and simple. Sun visors are prone to dirt, grease, or grime because drivers are always reaching for them during the drive to either block or unblock the sun. The present invention offers a low-cost and simple way to easily beautify and protect sun visors.

### CROSS-REFERENCE TO PRIOR APPLICATIONS

The present application is related to abandoned application Ser. No. 10/229,526, by the present inventors.

### FIELD OF THE INVENTION

The present invention relates to the field of automobile accessories, and more particularly to protective covers for automobile accessories.

### DESCRIPTION OF RELATED ART

The prior art has developed a variety of attachable after-market automobile sun visors with multiple purpose applications. The focus of most prior embodiments is the addition of certain extra features, which allow the visor to serve several new and different functions, including holding sunglasses, maps, and a limited number of compact discs.

A previous device related to the present design was developed for the sole purpose of providing a more attractive alternative to a damaged, unsightly sun visor.

Another related invention has been developed for the restoration or replacement of a vehicle sun visor. It offers a frame or stiff foam plastic structure, which can be cut into the desired shape or model of visor needed. The foam plastic is then inserted into a stretchable or heat shrinkable fabric cover. The finished product is then attached to the automobile.

### BRIEF SUMMARY OF THE INVENTION

It is an object of the present invention to preserve the integrity of your automobile sun visor.

It is a further object of the present invention to provide a fashionable alternative to an already drab, sun-faded automobile visor.

It is the very nature of a sun visor to be in the harsh rays of direct sunlight a majority of the time. After daily handling and sun damage have taken their toll, a sun visor can become faded, cracked, and unsightly. Prior art has developed many inventions designed for the expeditious repair, restoration, or replacement of the sun visor. While these inventions provide a capable means of achieving their intended purpose, they are only designed to correct a pre-existing problem. Many are irremovable and unalterable once applied, and may cause further damage if removed.

The present invention was designed for the purpose of protecting a new or otherwise intact automobile sun visor. It has a simple, self-explanatory design and takes only minutes to apply. It is constructed of machine washable materials (an elastic cotton blend) available in a variety of colors and designs, much like a car seat cover. Indeed, the present invention can be fabric and color-coordinated to match an existing or new car seat cover.

The present embodiment is comprised of a hollow sleeve that is closed on one end and open on the other, conforming closely to the outside surface dimensions of the sun visor. It is easily applied onto an existing visor, in the manner of a slipcover. When it has become faded, torn, or dirty the cover is easily removed and leaves no marks on the existing sun visor. It can be washed and replaced quickly and easily.

A small thin aperture is utilized on the front of the present embodiment to allow the support arm of the sun visor to enter through to allow for easy installation and removal of the device. The present embodiment is also installed or removed without the aid of tools, which ensures simplicity, ease, and little time.

The present invention provides a simple and convenient way to protect your sun visor and maintain the beauty of your cars interior.

### BRIEF DESCRIPTION OF THE DRAWINGS

FIG. 1: Shows the backside of the present embodiment where overlapping flaps are visible to slide over and cover the existing visor.

FIG. 2: Shows the front side of the present embodiment, as it would be visible from the exterior of the windshield.

FIG. 3: Shows the backside of the present embodiment as mounted on the visor.

FIG. 4: Shows the front side of the present embodiment as mounted on the visor.

FIG. 5: Displays the three components of the present embodiment in disassembled form.

FIG. 6: Shows the initial assembly process of the present embodiment of the current invention.

FIG. 7: Shows the stitching used as the final part of the assembly process for an altenate embodiment of the present invention, with a top access slot.

### DETAILED DESCRIPTION OF THE INVENTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as representative basis for teaching one skilled in the art to employ the present invention in virtually any appropriately detailed system, structure or manner.

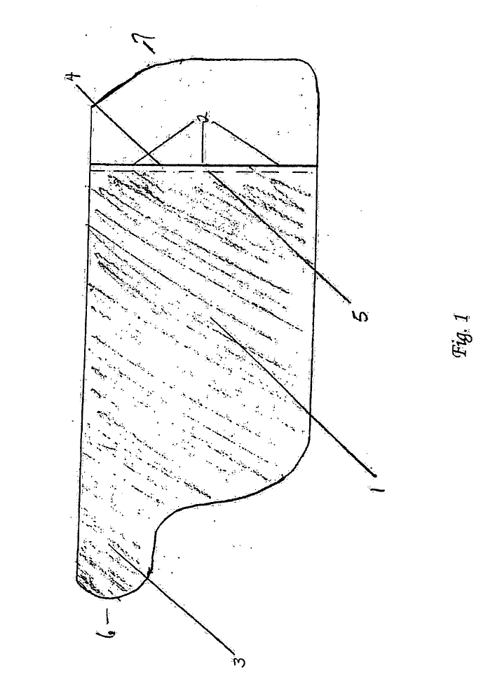

FIG. 1: The backside of the present embodiment shows the flaps 4,5 that enable the sun visor to be inserted into the device and therefore protected. There are two flaps 4,5, one 5 overlapping the other 4, similar to a pillowcase, thus allowing the open end to be closed. This ensures full coverage and protection of the sun visor. The present embodiment is constructed of an elastic, cloth blend 1 that is soft, but durable and easily washable. Proper design of the present embodiment is utilized to ensure best closure and fit. The present embodiment also features easy, tool-free installation and removal, which does not require removal of the sun visor to accomplish these tasks. Installation just requires slipping on the present embodiment, which is hollow and closed on one side in a sealed nose 6 and open on the other side 7, starting with the side nearest the support arm 3 (hidden in this view) continuing until the overlapping flaps 4,5 cover and conform closely to the outside surface dimensions of the visor and the flaps are pressed shut. These features allow the installation of the present embodiment to be very simple and trouble-free, taking little time and allowing car owners with little or no mechanical experience to install or remove this device.

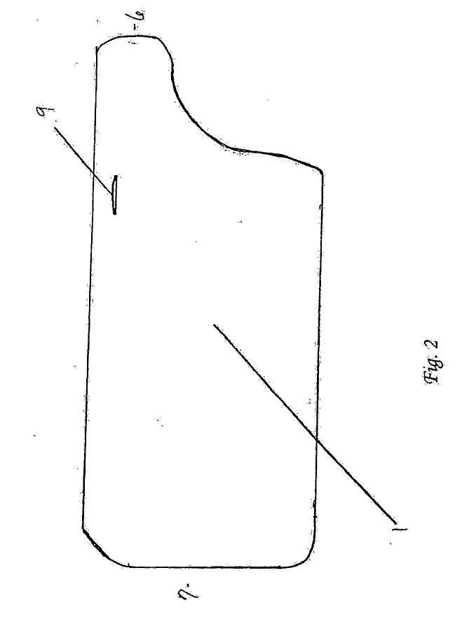

FIG. 2: The front side of the present embodiment features a single piece of fabric with a small aperture 9 at the top right of the embodiment 6; its purpose is to allow entry for the support arm. The aperture 9 is just long and wide enough to allow the support arm to enter through to ensure a clean and stealth appearance. The front side of the present embodiment would be free of any pockets or flaps ensuring a clean, flat appearance. The present embodiment features an elastic cloth surface 1 that is soft, durable, and form fitting to properly cover the visor. The present invention also features easy, tool-free installation and removal and does not require the removal of the sun visor itself. These features allow the installation of the present embodiment to be very simple and trouble-free, taking little time and allowing car owners with little or no mechanical experience the ability to install or remove this device.

Utilization of the present embodiment just requires the car owner to slip the open side 7 onto the visor until reaching the end at the closed side 6 and using the aperture 9 to allow the support arm to enter through, and close the overlapping flaps as evident in FIG. 1 for proper closure and fit.

Because of the materials and low manufacturing costs of the present embodiment, this device would be very cost effective solution for many car owners. In the same scenario as car owners cover their nice, new seats; car owners will be able to cover their sun visors in the same way. The thin, lightweight, non-obstructive nature of the present embodiment creates a protective, low-cost cover, which will not inhibit the movement or create sag when installed.

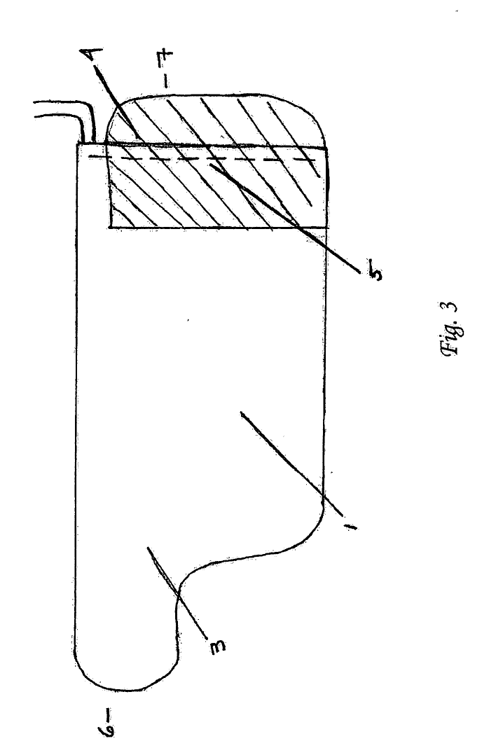

FIG. 3 shows the back side of the present invention as mounted on the visor. The support arm 3 from the visor is visible at the top right, but the largest portion is not visible, as it is hidden by the surface 1 of the cover. The closure flaps 4, 5 are visible next to the open side 7. The support arm 3 extends through the top of the present invention, and ends short of the nose at the closed end 6.

Note that the support arm 3 is not part of the current invention, and is hereby expressly disclaimed. The support arm is, however, an essential feature of standard automobile sun visors, for which the current invention is designed to cover and protect.

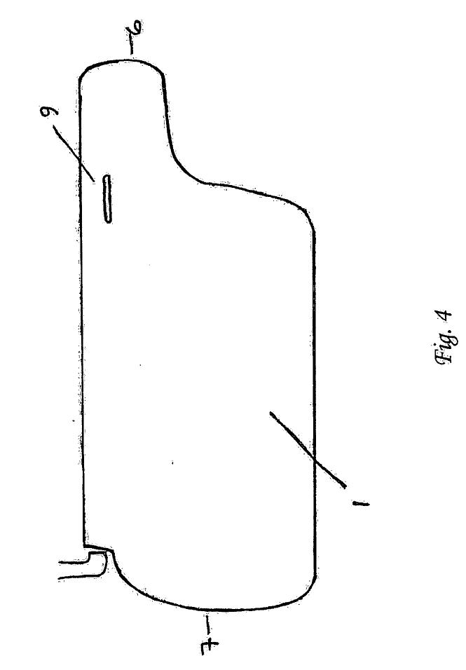

FIG. 4 illustrates the visor cover as mounted on a visor, from the front side. The aperture 9 for entry of the support arm 3 is clearly shown. The support arm itself is visible at the upper left of the figure.

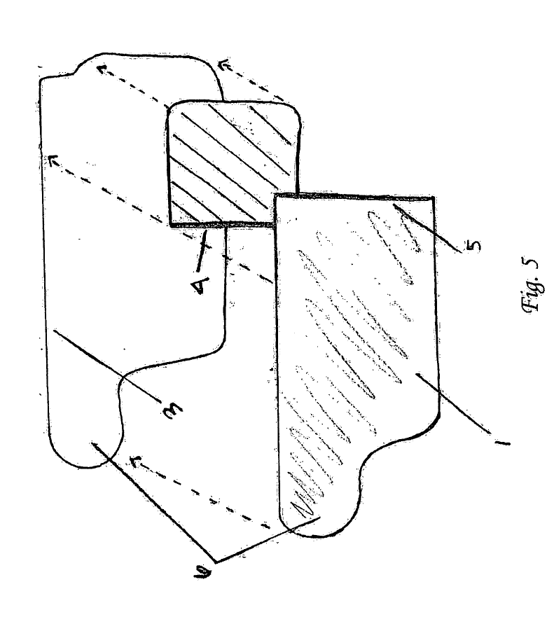

FIG. 5 displays one method of manufacture of the present invention. In this case, two identical pieces are fastened together—a front half 10 and a back half 20. Both halves are nearly mirror images of each other, except that half 20 is slightly trimmed at the upper edge of the open side 7.

A third, smaller piece 30 is also incorporated in this assembly. Piece 30 will become part of the flap 4 that is used in conjunction with flap 5 to form the closure apparatus. Flap 5 is not an independent piece, but rather is formed from the open end of piece 10, as shown.

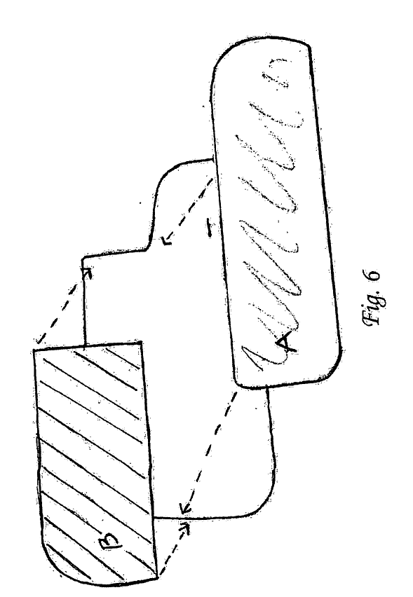

FIG. 6 displays an alternative mode of assembly of an alternate embodiment of the present invention. In this mode, half 20 is mated with two new pieces 40, 50, marked A and B respectively, as they might be in a standard pattern. Part 40 is an elongated piece that is only half the height of the finished product. It extends along the lower edge of the invention. Part 50 is a shorter, stubbier piece that extends along the top edge from the taller side to the point where visor cuts down in height, and forms a curve approaching the nose 6 at the closed end. In this assembly, a new embodiment is created that has both sides closed, but an open side halfway up the visor, where parts 40 and 50 meet. This embodiment is used for the unusual visors, which are best covered by a cover accessible from the top, as opposed to the side.

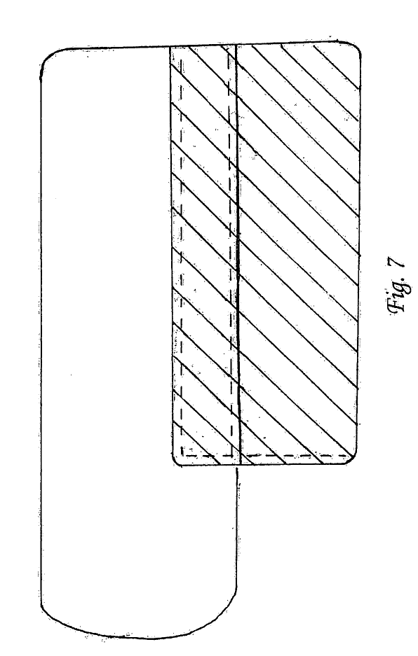

The finished view of this alternate embodiment is displayed in FIG. 7. Here the final stitching can be seen. A flap or open pouch is formed, with open mouth along the line between points 45 and 55 along the midpoint of the device.

While the present invention has been described in terms of several preferred embodiments, it is not intended to limit the invention to the particular forms set forth. On the contrary, the present invention is intended to cover such alternatives, alterations, modifications, and equivalent structures and devices as may be included within the spirit and scope of the invention as defined within the appended claims.

1. A cover for the sun visor of an automobile or other vehicle, comprising:
a. a hollow sleeve, closed on one end and open on the other;
b. said sleeve conforming closely to the outside surface dimensions of said visor;
c. said sleeve capable of being fitted over said visor; and,
d. said sleeve possessing a through aperture on one face, said through aperture suitably sized and positioned for insertion of the support arm of said visor.

2. The cover of claim 1, further comprising an overlapping section near said open end to allow said open end to be closed.

3. The cover of claim 1, further comprising elastic material for enabling closure.

4. The cover of claim 1, further comprising cloth as material of construction.

5. The cover of claim 1, further comprising a hook and loop closure surrounding said aperture.

6. The cover of claim 1, wherein said cover is capable of being removed from said visor without the aid of tools.

7. The use of the cover of claim 1 to enclose a sun visor of an automobile.

8. The method of construction of the cover of claim 1, said method comprising the assembly of a plurality of parts, and fixed attaching each to the other, such that at least one opening is created suitable for allowing the cover to be placed over a sun visor.
